(19) United States
(12) Patent Application Publication
(10) Pub. No.: US 2010/0036542 A1
(43) Pub. Date: Feb. 11, 2010

(54) SYSTEM FOR SETTING A POSITIONING MEMBER

(76) Inventor: Thomas Karte, Bruchkoebel (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/535,800

(22) Filed: Aug. 5, 2009

(30) Foreign Application Priority Data
Aug. 8, 2008 (DE) 10 2008 037 108.4

(51) Int. Cl. G05B 9/02; H01H 47/00; G05D 3/00

(52) U.S. Cl. 700/302; 361/170; 700/21

(57) ABSTRACT

In a system or method for setting a positioning member, a pneumatic positioning drive actuates the positioning member, the pneumatic positioning drive having at least two control positions and a predetermined safety position. A position controller is pneumatically coupled to the positioning drive. A basic process control system generates and transmits a set-point signal for the positioning member. A safety controller generates and transmits a safety signal with which the pneumatic positioning drive is vented causing the positioning member to automatically move into the predetermined safety position. The basic process control system and the safety controller are coupled with respect to signal transmission in such a way that the set-point signal generated by the basic process control system is transmitted via the safety controller and a signal transmission path coupling the position controller with the safety controller.

### BACKGROUND

The preferred embodiment relates to a system for setting a positioning member, such as a control valve of a processing plant such as a petrochemical plant, or a power plant such as a nuclear power plant.

In such a plant, it is necessary to control the flow of a process fluid as a function of process parameters. In addition to the control function, in which they can adopt at least two positions, some of the control valves for the above-mentioned purpose also have a safety shut-off function, in which for example a complete shut-off of the control valve is to be initiated. Depending on the safety regulation in the respective processing field, it can be appropriate to use a pneumatic drive for setting the control valve. It is to be understood that also hydraulic or electric drives can be used according to the preferred embodiment. The pneumatic drive is well-suited for control valves with an automatic safety function because of its simple mechanical structure. If the pneumatic drive is vented, built-in springs will cause automatic movement into the safety position. This structure has high reliability.

It is known to control the pneumatic position of a control valve via a so-called controller having a pneumatic control output. Besides analogue and digital electric components especially valve processing of positioning signals of the control valve, such a position controller also features a current/pressure-converter (IP-converter) which is actuated by an electric signal and controls the pneumatic positioning drive. The position controller receives control valve set-point signals via a superordinate basic process control system. Initiated for example by manual input of an operating person or by a control routine with electronic processing of several process parameters, the basic process control system generates the control valve set-point signal and outputs it to the position controller for further positioning member-specific processing. Thereby, commonly a 4 to 20 mA signal is sent from the basic process control system to the position controller. This basic process control system controls the plant during normal operation, that is, as long as no disturbances are present.

Such an arrangement comprised of a positioning member with a safety position, a position controller connected to the basic control system and the pneumatic drive often also contains a safety system for the processing plant, commonly referred to as a “safety instrument system”. This safety system comprises a so-called logic solver, which is a type of computer acting as a safety controller.

According to the operational requirements, the safety controller controls the valve with a shut-off function via an electric line by providing a 24 V signal during normal operation and shutting off the signal in the case of an emergency situation of the plant, which corresponds to a so-called 0V-signal. The safety controller is operating self-sufficient and independent from the basic process control system. The safety controller switches off the respective valve without the need for action by an operation person via the basic process control system.

Furthermore, in some processing plants, there are devices enabling testing of the safety system. Testing safety relevant circuits requires verification of the correct flow of signals from the safety controller to the valve and to document the correct functioning of all components.

A known generic system for setting a control valve is shown in FIG. 1 of the enclosed schematic drawings, wherein the position control system is generally denoted with the reference numeral a. The known position control system a comprises a basic process control system b which is connected to the position controller b via an electric line c. The position controller d comprises a microprocessor (not shown) which processes the position set point signals issued by the basic process control system b and transmits them to an internal IP-converter (not shown) which controls a pneumatic positioning drive e via a pneumatic line l. The pneumatic positioning drive e correspondingly operates a control valve f.

Alongside the basic process control system b, there is a separate self-sufficiently working safety controller g which is connected with its own IP-converter being an electro-valve o via its own signal transmission line h.

Electro-valve o acts on the pneumatic control line l between the position controller d and the pneumatic positioning drive e. The safety controller g is connected with a position controller via a line transmitting the above described 24 V/0 V-signal to electro-valve o. In case of an emergency situation in the processing plant, the safety controller g will generate the 0V-signal causing electro-valve o to separate the connection between the position controller d and drive e. Thereby, one pressure chamber of the pneumatic drive e is connected to the atmosphere, which causes the pneumatic drive e to be vented. In case of a complete power failure of the processing plant the 24 V permanent operating signal will be missing and the 0V signal will be present at the electro-valve o causing the pneumatic drive e to vent and the control valve f to move into the emergency position.

The pneumatic positioning drive e can also be vented by means of transmission of a respective signal from the basic process control system b via the signal line c to position controller d and the IP-converter contained therein.

An example of such a position control system is given in DE 10 2004 004 477 A1. A disadvantage of the known position control system is the fact that it has a complex structure due to the multitude of components resulting from the arrangement of IP-converters and respective pneumatic lines installed for safety reasons. A further disadvantage is the high cost caused especially by the two connections between the basic control system and the position controller and between the safety controller and the electro-valve, both of which can be of considerable length. The basic process control system and the safety controller are usually located in a so-called control room which is often far away from the location of field instruments. Additional to the costs of the electric lines, the costs for respective isolation amplifiers for feeding the signals into explosion-prone areas are also to be considered as well as costs for output cards of the respective systems, and costs for putting into service, testing and documenting. A further disadvantage concerns the testing of the safety circuit. While the control valve can be completely tested according to the state of the art, testing of the electro-valve is difficult, since there is a risk of involuntary closing of the valve.

### SUMMARY

It is an object to overcome the disadvantages of the prior art, especially the known system for setting a positioning member such as a control valve of a processing plant. First its structure is to be significantly simplified concerning costs and assembly without loss of control function and emergency functions of the system. Secondly, testability of all components of the safety circuit should be provided.

In a system or method for setting a positioning member, a pneumatic positioning drive actuates the positioning member, the pneumatic positioning drive having at least two control positions and a predetermined safety position. A position controller is pneumatically coupled to the positioning drive. A basic process control system generates and transmits a set-point signal for the positioning member. A safety controller generates and transmits a safety signal with which the pneumatic positioning drive is vented causing the positioning member to automatically move into the predetermined safety position. The basic process control system and the safety controller are coupled with respect to signal transmission in such a way that the set-point signal generated by the basic process control system is transmitted via the safety controller and a signal transmission path coupling the position controller with the safety controller.

### BRIEF DESCRIPTION OF THE DRAWINGS

FIG. 1 is a schematic diagram of a prior art system for setting a positioning member; and

FIG. 2 is a schematic diagram of a system of the preferred embodiment for setting a positioning member.

### DESCRIPTION OF THE PREFERRED EMBODIMENT

For the purposes of promoting an understanding of the principles of the invention, reference will now be made to the preferred embodiment/best mode illustrated in the drawings and specific language will be used to describe the same. It will nevertheless be understood that no limitation of the scope of the invention is thereby intended, and such alterations and further modifications in the illustrated device and such further applications of the principles of the invention as illustrated as would normally occur to one skilled in the art to which the invention relates are included.

Accordingly, the system for setting a positioning member, such as a control valve of a processing plant, which can be actuated through a pneumatic positioning drive and which, besides its at least two control positions, can further adopt a safety position, particularly in case of an emergency situation of the processing plant, comprises a position controller for controlling the positioning drive. Furthermore, the setting system comprises a basic process control system superordinate to the position controller for generating and transmitting a set-point signal for the positioning member, such as a 4 to 20 mA signal, to the position controller and a safety controller alongside the basic process control system for generating and transmitting a safety signal, such as a 0 or 24 V-signal. The safety signal causes the pneumatic positioning drive to vent, which causes the positioning member to automatically move into a predetermined safety position. According to the preferred embodiment, the basic process control system and the safety controller are coupled with respect to their signal transmission in such a way that the position set-point signal is transmitted to the position controller via the safety controller and via a signal transmission coupling the position controller with the safety controller. With the signal transmission from the basic process control system to the position controller exclusively via the safety control system according to the preferred embodiment, signal transmission lines are used which are already present in the system. A signal line particularly dedicated for transmission from the basic process control system to the position controller is unnecessary. Furthermore, isolation amplifiers, output cards, pneumatic switches as well as an electro-valve exclusively dedicated to the safety control system or the basic process control system can be spared. For diagnosing procedures for the positioning device according to the preferred embodiment a significant reduction for potential sources of error is realized.

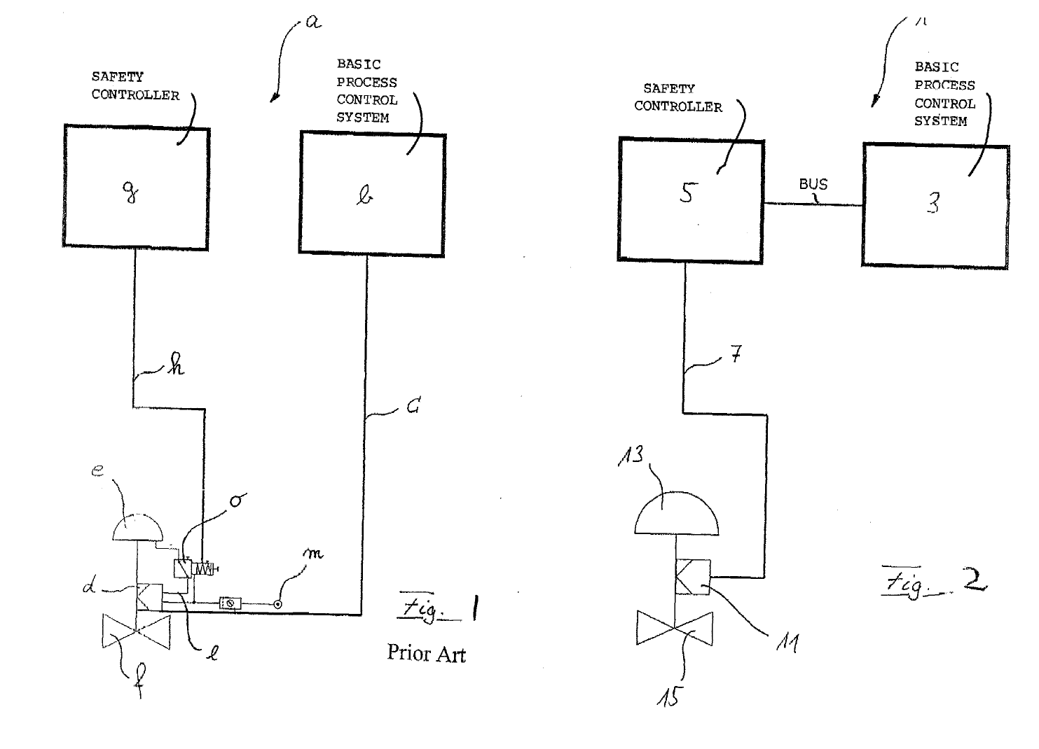

Compared to the known positioning system shown in FIG. 1, a signal transmission line h is not connected with its own electro-valve o anymore but is connected directly to the position controller, which has its own internal IP-converter. Surprisingly, the preferred embodiment revealed that coupling the safety controller with a position controller provides safe moving of the positioning member into the safety position, even though the safety controller directly controls the position controller, which usually is only controlled by the basic process control system.

In a preferred embodiment, the basic process control system is coupled with the position controller exclusively via the safety control system. This renders redundant a transmission line particularly dedicated to the basic process control system, as it is known from the prior art. All control signals are transmitted to the position controller and the located IP-converter via the lines connecting the safety controller with the position controller. In order to simultaneously transmit a safety signal as well as a control signal via the same line, the HART-protocol can be used for example. Preferably, the basic process control system and the safety controller are coupled by a BUS. Here, for example, the communication system known under the product name MODBUS RTU can be used, which is offered by the companies Honeywell and HIMA. In the case of the so-called MODBUS-communication of Honeywell, a PLC-gateway acts as a MODBUS-master, and a HIMA-controller acts as a so-called MODBUS slave. The MODBUS-slave-functionality is generally integrated into the HIMA-operating system. Preferably the connection between the safety controller and the position controller is formed as a wire connection. The signal used is preferably the so-called 4 to 20 mA-signal in two-line technology. However, also other signals, such as a digital connection via a field bus, are possible.

The safety controller is preferably provided with a decision logic which distinguishes the normal state and the failure state. If the normal state is present, a signal corresponding to the signal received from the basic process control system is fed into the line to the position controller. If a failure state is present, a safety signal for venting the position controller is fed into the line.

In a further embodiment, concerning an arrangement comprised of one pneumatic positioning drive and one positioning member, the position controller has only one IP-converter which receives an electric positioning signal as well as an electric safety signal from an electronic component of the position controller, which component in turn receives the position set-point signal from the basic process control system as well as the safety signal for the forced venting of the pneumatic positioning drive from the safety controller.

In a preferred embodiment, the intelligent position controller has an additional circuit generating a safety signal inside the position controller for venting the pneumatic positioning drive also if the position controller receives a position set-point signal having a voltage or current value above or below a circuit-specific threshold value. The circuit threshold value can be for example 4 mA. If a signal with a 4 mA value reaches the position controller, the circuit of the position controller will switch the internal IP-converter to vent the pneumatic drive.

Preferably, an IP-converter will vent the pneumatic positioning drive if the position controller receives a 4 mA signal from the basic process control system or receives no current from the safety controller. The 4 mA signal as well as the no-current signal (power supply completely switched off) is transmitted via the same signal transmission line.

Preferably, the signal transmission line connecting the position controller with the safety controller is a wire connection.

Preferably, the position controller has a sensor, especially a position sensor, which can communicate with the basic process control system via the signal transmission between the position controller and the safety controller.

Preferably, the position controller, or the safety controller, or the basic process control system is provided with a diagnostic logic. This logic compares whether the signal of the position sensor is identical to the set-point of the position controller. If identity is present, it can be assumed that the complete signal chain including the IP-converter is working properly. Thus, a prognosis is possible concerning the probability of the safe shut-down in case of failure.

Finally, the preferred embodiment concerns a method for setting a positioning member, such as a control valve of a processing plant. The positioning member is actuated by a pneumatic positioning drive and shall be able to adopt a further safety position besides its control positions. Thereby a position set-point signal such as a 4 to 20 mA signal for the positioning member is generated by a basic process control system and transmitted to a position controller, whereby a safety system generates and transmits a safety signal such as a 0 or a 24 V signal in order to vent the pneumatic positioning drive and move the positioning member into a predetermined safety position. The position set-point signal for the positioning member of the basic process control system is transmitted via the safety system and a signal transmission coupling, the position controller with the safety system.

Preferably, the method according to the preferred embodiment is realized according to the functionality of the positioning system according to the preferred embodiment.

Further characteristics, advantages and features of the preferred embodiment will be become clear by the following description of a preferred embodiment in connection with the enclosed drawings in which FIG. 2 shows a schematic drawing of the system for setting a positioning member according to the preferred embodiment.

The position setting system according to the preferred embodiment in FIG. 2 has the reference numeral 1. At a higher order process level, the position setting system comprises a basic process control system 3 which can be responsible for several positioning members. Parallel thereto there is a safety controller 5, connected to the basic process control system 3 via a communication line. Thereby, a signal transmission line 7 as a transmission path, designed as a cable, connects the basic process control system 3 with a position controller 11 of the position setting system 1 via the safety controller 5.

The position controller 11 is not represented in detail but can be designed according to the embodiment of a position controller described in DE 10 2005 024 686 A1, especially according to the figure given therein. The structure of the position controller of DE 10 2005 024 686 A1 shall be considered as part of the present application documents by means of reference.

The position controller 11 operates according to the so-called life-zero-principle according to which the pneumatic output can be switched pressureless with high probability also in the case that an electrical signal of a certain magnitude is received via the signal transmission line 7. For that purpose, the position controller 11 has an additional electrical circuit (not shown) controlling a relay which switches the IP-converter into the currentless state. If the position controller 11 receives the life-zero-signal (4 mA) from the basic process control system 3, the IP-converter is switched currentless by the relay, whereby a pneumatic drive 13 is vented. The pneumatic positioning drive 13 self-actingly moves the control valve 15 into a predetermined safety position by means of releasing potential energy of pre-loaded compression springs.

The control valve 15 is also moved to the pre-determined safety position, if the safety controller 5 releases a safety signal in the form of a 0 mA signal. During normal operation, a value corresponding to the set-point value of the valve position between 4 and 20 mA is present at the output of the safety controller 5. If a power failure or an emergency situation of the processing plant causing a power failure occurs, the position controller 11 receives a “0 mA”-signal, whereupon the pneumatic positioning drive 13 will also vent via the IP-converter being switched energies.

According to the preferred embodiment, the control signals of the basic process control system 3 as well as the safety signal of the safety controller 5 are transmitted to only one IP-converter of the position controller 11 via one single transmission line 7.

While a preferred embodiment has been illustrated and described in detail in the drawings and foregoing description, the same is to be considered as illustrative and not restrictive in character, it being understood that only the preferred embodiment has been shown and described and that all changes and modifications that come within the spirit of the invention both now or in the future are desired to be protected.

I claim as my invention:

1. A system for setting a positioning member, comprising:
a pneumatic positioning drive which actuates the positioning member, said pneumatic positioning drive having at least two control positions and a predetermined safety position;
a position controller that is pneumatically coupled to said positioning drive for controlling the positioning drive;
a basic process control system for generating and transmitting a set-point signal for said positioning member;
a safety controller for generating and transmitting a safety signal with which said pneumatic positioning drive is vented causing the positioning member to automatically move into said predetermined safety position; and
said basic process control system and said safety controller being coupled with respect to signal transmission in such a way that said set-point signal generated by said basic process control system is transmitted via said safety controller and a signal transmission path coupling said position controller with said safety controller.

2. A system of claim 1 wherein said positioning member comprises a control valve of a processing plant.

3. A system of claim 2 wherein said pneumatic positioning drive safety position is adopted in case of an emergency situation of said processing plant.

4. A system of claim 1 wherein said set-point signal for the positioning member comprises a 4 to 20 mA signal.

5. The system according to claim 1 wherein the basic process control system is coupled with the position controller exclusively via the safety controller.

6. The system according to claim 1 wherein the basic process control system and the safety controller are coupled by a BUS.

7. The system according to claim 1 wherein the position controller has only one IP-converter which receives an electric positioning signal as well as an electric safety signal from an electronic component of the position controller.

8. The system according to claim 1 wherein the position controller has an additional safety circuit generating a safety signal inside the position controller for venting the pneumatic positioning drive also if the position controller receives a position set-point signal having a voltage or current value above or below a circuit-specific threshold value.

9. The system according to claim 8 wherein said circuit specific threshold value is 4 mA.

10. The system according to claim 1 wherein an IP-converter vents the pneumatic positioning drive if the position controller receives a 4 mA signal from the basic process control system or receives no current from the safety controller.

11. The system according to claim 1 wherein the signal transmission path is a wire connection.

12. The system according to claim 11 wherein a signal transmission within the wire connection is a digital signal formed according to a field bus protocol.

13. The system according to claim 1 wherein the position controller has a sensor, an output signal of which is communicated to the basic process control system via the signal transmission line and the safety controller.

14. The system according to claim 13 wherein said sensor comprises a position sensor.

15. The system of claim 14 wherein a diagnostic logic unit generates diagnostic information by comparing a signal of the position sensor to the set-point of the position controller, said diagnostic logic unit being disposed in the position controller, in the safety controller, or in the basic process control system.

16. A method for setting a positioning member, said positioning member having control positions and in addition a further predetermined safety position, said positioning member being operated by a pneumatic positioning drive, comprising the steps of:
generating a position set-point signal by a basic process control system and transmitting said position set-point signal to a position controller pneumatically coupled to said pneumatic positioning drive;
generating and transmitting, with a safety controller, a safety signal in order to vent said pneumatic positioning drive and move said positioning member into said further predetermined safety position; and
transmitting said position set-point signal from the basic process control system via the safety controller and a signal transmission path to said position controller.

17. A method according to claim 16 wherein said positioning member comprises a control valve of a processing plant.

18. A method according to claim 17 wherein said further predetermined safety position comprises an emergency situation of the processing plant.

19. A method according to claim 16 wherein said position set-point signal is 4 to 20 mA.

20. A method for setting a positioning member which actuates a control value of a processing plant, said positioning member having control positions and in addition a further predetermined safety position comprising an emergency situation of said processing plant, said positioning member being operated by a pneumatic positioning drive, comprising the steps of:
generating a position set-point signal by a basic process control system and transmitting said position set-point signal to a position controller pneumatically coupled to said pneumatic positioning drive;
generating and transmitting, with a safety controller, a safety signal in order to vent said pneumatic positioning drive and move said positioning member into said further predetermined safety position; and
transmitting said position set-point signal from the basic process control system via the safety controller and a signal transmission path to said position controller.
